(19) United States
(12) Patent Application Publication
(10) Pub. No.: US 2008/0102177 A1
(43) Pub. Date: May 1, 2008

(54) Method of purifying theavlavins

(75) Inventors: Henricus Otto Franciscus Molhuizen, AT Vlaardingen (NL); Theodorus Pierre Jacques Mulder, AT Vlaardingen (NL); Mario Adriaan Vermeer, AT Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/893,060

(22) Filed: Aug. 14, 2007

(30) Foreign Application Priority Data
Aug. 14, 2006 (EP) EP06118862

(51) Int. Cl. A23F 3/00

(52) U.S. Cl. 426/422

(57) ABSTRACT

The present invention provides a method of producing a theaflavin composition rich in mono-gallated theaflavin. The method comprises the steps of: a) providing a mixture of theaflavins; b) contacting the mixture of theaflavins with phospholipid and a solvent thereby to form a complex comprising the phospholipid and the theaflavin composition; and c) separating the complex from the remaining theaflavins.

### TECHNICAL FIELD OF THE INVENTION

The present invention relates to methods for selectively purifying theaflavins. More particularly, the present invention relates to the use of phospholipids for purifying mono-gallated theaflavins from a mixture of theaflavins.

### BACKGROUND OF THE INVENTION

Tea is one of the most widely consumed beverages in the world. Various kinds of tea are produced from the same species of plant, Camellia sinensis. Teas are classified into three major categories according to the manufacturing process: unfermented (green) tea, partially fermented (oolong) tea, and fully fermented (black) tea.

Steaming or drying fresh tea leaves at elevated temperatures makes commercial green tea. Its chemical composition is similar to that of fresh tea leaves. Green tea contains polyphenols, which include flavanols, flavonol glycosides, and phenolic acids; these compounds may account for up to 30% of the dry weight. Most of the green tea polyphenols are flavanols, commonly known as catechins. Some major green tea catechins are epigallocatechin-3-gallate (EGCg), epigallocatechin (EGC), epicatechin-3-gallate (ECg), epicatechin (EC), gallocatechin (GC), and catechin (C).

Oolong tea, a partially fermented tea, contains monomeric catechins, theaflavins, and thearubigins. Some characteristic components, such as epigallocatechin esters, theasinensins, and polymeric catechins (proanthocyanidins), are found in oolong tea. In the manufacture of black tea, the monomeric flavan-3-ols undergo polyphenol oxidase-dependent oxidative polymerization leading to the formation of bisflavanols, theaflavins, thearubigins, and other oligomers in a process commonly known as “fermentation”. Theaflavins make up about 1-2% of the total dry matter of black tea and are thought to give the characteristic colour and taste of black tea. About 10-20% of the dry weight of black tea is thearubigins, which are even more extensively oxidized and polymerized, have a wide range of molecular weights, and are less well characterized than theaflavins.

Several studies have suggested that black tea has a number of health-related benefits. Furthermore, theaflavins have been indicated as contributing to at least some of these benefits, including antioxidant benefits, antipathogenic benefits and anti-cancer benefits. Furthermore, theaflavins have been shown to prevent coronary heart disease and to treat diabetes in clinical trials. German patent application DE 196 27 344 (Vitasyn GmbH) discloses compositions comprising theaflavins for providing a range of health-related benefits.

US patent application US 2004/0097432 (Haeri Roh-Schmidt and James B. Roufs) reports that theaflavins inhibit cholesterol synthesis. This document also reports that the mono-gallated theaflavin theaflavin-3-gallate provides much of the observed cholesterol inhibition activity.

Unfortunately, however, the mixture of theaflavins produced during fermentation of tea typically comprises less than 40% mono-gallated theaflavins by weight (see, for example, p. 568 in Chapter 17 of “Tea—Cultivation to consumption”, K. C. Willson and M. N. Clifford (Eds), 1992, Chapman & Hall, London).

Thus we have recognised that there is a need to provide compositions enriched in mono-gallated theaflavin.

International patent applications WO 03/045328 and WO 2004/112715 (Jian Zhao et al) each disclose a method for making theaflavin, theaflavin-3-gallate, theaflavin-3′-gallate and theaflavin-3,3′-digallate, each as a separate compound. The method comprises the step of contacting a mixture of theaflavins with an organic solvent; contacting the solvent with dilute aqueous base; separating the solvent from the base; contacting the solvent with a chromatographic media; and eluting the theaflavin, theaflavin-3-gallate, theaflavin-3′-gallate and theaflavin-3,3′-digallate, each as a single compound, from the chromatographic media. Unfortunately, this method involves the use of expensive and/or environmentally unfriendly materials such as organic solvents and chromatographic media.

Surprisingly, we have found that mono-gallated theaflavins preferentially interact with phospholipids. Thus we have recognised that this interaction may be used to selectively purify mono-gallated theaflavins in a convenient way.

### SUMMARY OF THE INVENTION

Thus, the present invention provides a method of producing a theaflavin composition rich in mono-gallated theaflavin, the method comprising the steps of:
a) providing a starting mixture of theaflavins;
b) contacting the starting mixture of theaflavins with phospholipid and a solvent thereby to form a complex and remaining theaflavins, the complex comprising the phospholipid and the theaflavin composition rich in mono-gallated theaflavin;
c) separating the complex from the remaining theaflavins;
d) optionally recovering the theaflavin composition from the complex; and
e) optionally recycling the phospholipid.

The present invention also provides use of a phospholipid for purifying mono-gallated theaflavin.

### DETAILED DESCRIPTION

### Providing the Starting Mixture of Theaflavins

As used herein the term “theaflavins” is used as a generic term for theaflavin, isotheaflavin, neotheaflavin, theaflavin-3-gallate, theaflavin-3′-gallate, theaflavin-3,3′-digallate, epitheaflavic acid, epitheaflavic acid-3′-gallate, theaflavic acid, theaflavic acid-3′-gallate and mixtures thereof. The structures of these compounds are well-known (see, for example, structures xi-xx in Chapter 17 of “Tea—Cultivation to consumption”, K. C. Willson and M. N. Clifford (Eds), 1992, Chapman & Hall, London, pp. 555-601). The term theaflavins includes salt forms of these compounds.

The theaflavins most abundant in natural sources, such as black tea, are theaflavin, theaflavin-3-gallate, theaflavin-3′-gallate, theaflavin-3,3′-digallate and mixtures thereof. Thus it is preferred that the starting mixture of theaflavins comprises theaflavin, theaflavin-3-gallate, theaflavin-3′-gallate and theaflavin-3,3′-digallate.

As used herein, the term “tea” refers to material from Camellia sinensis var. sinensis and/or Camellia sinensis var. assamica. The material may have been subjected to a so-called “fermentation” step wherein it is oxidised by certain endogenous enzymes that are released during the early stages of “black tea” manufacture. This oxidation may even be supplemented by the action of exogenous enzymes such as oxidases, laccases and peroxidases. Alternatively the material may have been partially fermented (“oolong” tea) or substantially unfermented (“green tea”).

Tea is a rich, natural source of theaflavins and so it is preferred that the theaflavins are derived from tea, more preferably from black tea.

The starting mixture of theaflavins may be provided as part of a mixed composition. Such a mixed composition may, for example, be a tea extract and comprise tea solids such as catechins, thearubigins, caffeine, theanine, GABA (gamma-aminobutyric acid) and mixtures thereof. It is preferred, however, that the starting mixture of theaflavins is provided in substantially pure form, as this ensures that minimal impurities are present that may competitively interact with the phospholipid and/or complicate further purification of the theaflavins. Thus, when present as part of a mixed composition, the mixed composition preferably comprises at least 50% of the starting mixture of theaflavins by dry weight of the mixed composition, more preferably at least 75% and optimally from 85 to 100%.

Methods for making a mixture of theaflavins in substantially pure form from tea are described, for example, in WO 03/045328 (Nashai Biotech LLC) and U.S. Pat. No. 5,532,012 (Balentine et al.).

Although the method of the present invention may be advantageously used with a starting mixture of theaflavins comprising relatively high amounts of mono-gallated theaflavin (e.g. from 50 to 95% mono-gallated theaflavin by weight of the starting mixture), the method is preferably used with a starting mixture of theaflavins comprising less than 50% mono-gallated theaflavin by weight of the starting mixture, more preferably between 1 and 45% by weight of the starting mixture of theaflavins.

At least some of the theaflavins in the starting mixture may be synthesised from isolated catechins. The catechins may be isolated from a natural source, such as tea, or may themselves be synthetic.

Contacting the Starting Mixture of Theaflavins with Phospholipid

We have found that contacting a mixture of theaflavins with phospholipid produces a complex wherein the theaflavin composition associated with the phospholipid is enriched in mono-gallated theaflavin compared to the mixture of theaflavins.

As used herein, the term “complex” refers to a non-covalent association of phospholipid with a theaflavin composition. Thus the term encompasses such entities as aggregates, micelles, vesicles and the like. The term “remaining theaflavins” refers to those theaflavins not associated with the phospholipid.

The term “phospholipid” refers to a lipid or glyceride that contains a phosphate group. Thus the phospholipid may be, for example, lecithin (phosphatidyl choline), phosphatidyl ethanolamine, phosphatidyl inositol, phosphatidyl serine, diphosphatidyl glycerol (cardiolipin), dilauroyl phosphatidyl choline, dimyristoyl phosphatidyl choline, dipalmitoyl phosphatidyl choline, distearoyl phosphatidyl choline, dioleoyl phosphatidyl choline, dimyristoyl phosphatidyl ethanolamine, dipalmitoyl phosphatidyl ethanolamine, dipalmitoyl phosphatidyl glycerol, dimyristoyl phosphatidic acid, dipalmitoyl phosphatidic acid, dipalmitoyl phosphatidyl serine, dipalmitoyl sphingomyelin, 1-stearic acid-2-palmitoyl phosphatidyl choline, polyethylene glycol-2-stearoyl phosphatidyl ethanolamine, or a mixture thereof. Phosphatidyl choline is particularly preferred owing to its wide availability and food-compatibility. More preferably, the phosphatidyl choline is a food-grade lecithin such as egg yolk lecithin, soy bean lecithin or a mixture thereof.

The amount of mono-gallated theaflavin in the theaflavin composition rich in mono-gallated theaflavin will depend upon the amount of mono-gallated theaflavin in the starting mixture of theaflavins. However, the theaflavin composition will typically have a weight fraction of mono-gallated theaflavin at least 1.1 times the weight fraction of mono-gallated theaflavin in the starting mixture of theaflavins, i.e., the ratio R is given by equation (1):
R=(c_{MT}/c_{TOTAL})/(m_{MF}/m_{TOTAL})≧1.1 (1)
wherein c_{MF} is the mass of mono-gallated theaflavin in the theaflavin composition, c_{TOTAL} is the total mass of theaflavins in the theaflavin composition, m is the mass of mono-gallated theaflavin in the starting mixture of theaflavins and TOTAL is the total mass of theaflavins in the starting mixture of theaflavins. More preferably R is at least 1.2, most preferably from 1.5 to 1000.

Alternatively or additionally, the theaflavin composition may comprise at least 50% mono-gallated theaflavin by weight of the theaflavin composition, more preferably at least 70% and most preferably from 80 to 100%.

The most naturally abundant mono-gallated theaflavins are theaflavin-3-gallate and theaflavin-3′-gallate. Thus it is preferred that the mono-gallated theaflavin is theaflavin-3-gallate, theaflavin-3′-gallate or a mixture thereof. The most preferred mono-gallated theaflavin is theaflavin-3-gallate as this has been found to be particularly active, especially at reducing harmful blood lipids. Preferably, therefore, the mono-gallated theaflavin comprises at least 50% theaflavin-3-gallate by weight of the mono-gallated theaflavin, more preferably at least 75%, and most preferably from 80 to 100%.

The starting mixture of theaflavins is contacted with the phospholipid in a solvent, preferably an aqueous solvent. The solvent is preferably one in which the remainder of the theaflavins are soluble whilst the complex of phospholipid and the theaflavin composition remains intact. In a particularly preferred embodiment, the solvent is such that the remainder of the theaflavins are soluble whilst the intact complex is precipitated, as this allows for simple separation of the complex from the remaining theaflavins.

By “aqueous solvent” is meant a solvent comprising at least 50% water by weight of the solvent. Preferably the aqueous solvent comprises at least 80% by weight of water, more preferably at least 90% and optimally from 95 to 100%. The aqueous solvent may have a pH of from 2 to 10, more preferably from 4 to 8 and optimally from 5.5 to 7.5 at 20° C. This pH is suitably achieved by the presence of a buffer in the aqueous solvent. The solvent may, for example, advantageously comprise a phosphate buffer such as phosphate buffered saline.

The starting mixture of theaflavins and phospholipid are contacted for sufficient time to form the complex. Typically this time will be from 1 second to 24 hours, more preferably from 1 minute to 5 hours and most preferably from 5 minutes to 1 hour. Where the starting mixture of theaflavins and phospholipid are contacted in a continuous manner, the aforementioned time will be the average residence time in which the starting mixture of theaflavins and phospholipid are in contact.

The temperature of contact need not be extreme and is typically of the order of 1 to 70° C. More preferably from 5 to 50° C. and most preferably from 10 to 40° C.

Preferably the weight ratio of phospholipid to the starting mixture of theaflavins is from 1000:1 to 1:1000, more preferably from 100:1 to 1:100 and optimally from 10:1 to 1:10.

The contact may be quiescent but is preferably performed under agitation. The agitation may be mechanical, for example by stirring and/or flowing. Alternatively or additionally, the agitation may be effected by sonication.

Separating the Complex from the Remaining Theaflavins

The method of the invention comprises the step of separating the complex from the remaining theaflavins.

The separation may be effected, for example, by physical means. Such physical means include sedimentation (for example by centrifugation), filtration (for example by nano-filtration and/or ultrafiltration) or a combination thereof.

Additionally or alternatively the separation may be effected by chemical means. Such chemical means usually bring about a change in solubility of the complex or the remaining theaflavins in the solvent. This may be achieved, for example, by changing the solvent composition e.g. by adding an organic solvent to an aqueous solvent or by adding an aqueous solvent to an organic solvent. Other methods of altering solvent quality include adding salts, changing temperature and/or changing pH.

In a most preferred embodiment, the separation is achieved by sedimenting and/or precipitating the complex as a solid mass and then removing the solid mass from the remaining theaflavins in the solvent.

The remaining theaflavins may be discarded after the complex is separated therefrom. Alternatively they may be dried (for example by spray-drying or freeze-drying) and further used, for example in a pharmaceutical or food composition. In a particularly preferred embodiment, however, the remaining theaflavins are recovered and used as the starting mixture of theaflavins in step (a) of a repeat of the method of the invention.

Recovering the Theaflavin Composition

The theaflavin composition rich in mono-gallated theaflavin may be employed, for example, in pharmaceutical or food compositions as part of the complex. However, in a preferred embodiment, the theaflavin composition is recovered from the complex.

Recovery of the composition from the complex may comprise at least one unit operation selected from solvent extraction, electrodialysis, membrane separation and chromatography.

Solvent extraction may comprise extracting the theaflavin composition with a solvent in which theaflavins are highly soluble whilst the phospholipid is substantially insoluble.

Additionally or alternatively, the phospholipid may be extracted with a solvent in which phospholipid is highly soluble whilst theaflavins are substantially insoluble. In the former case, the solvent will usually be an organic solvent, whilst in the latter case the solvent will usually be a polar solvent such as an aqueous or alcoholic solvent.

Chromatography comprises contacting the theaflavin composition with a chromatographic medium, such as an adsorbent material. Preferably, prior to contact with the chromatographic medium, the theaflavin composition is extracted as described above. Alternatively, the complex may be dissociated (e.g. by contacting the complex with a solvent such as acetonitrile) prior to contacting the theaflavin composition with the chromatographic medium.

The theaflavin composition may be recovered as a single fraction or as multiple fractions. For example, the theaflavin composition may be recovered in multiple fractions, each fraction being enriched in an individual theaflavin. Use of a chromatographic medium is particularly suitable for recovering the theaflavin composition in such multiple fractions.

Once the theaflavin composition has been recovered from the complex it is preferably dried, for example by spray-drying or freeze drying.

The recovered theaflavin composition may be further enriched in mono-gallated theaflavin by using the composition as the starting mixture in step (a) in a method of the invention.

Recycling of the Phospholipid

In a particularly preferred embodiment the phospholipid is also recovered from the complex and then recycled. By “recycled” is meant that the recovered phospholipid is used as at least part of the phospholipid in step (a) of a repeat of the method according to the invention.

### EXAMPLES

The present invention will be further described with reference to the following examples.

### Example 1

This Example demonstrates a method according to the invention wherein the complex is in the form of simulated gastro-intestinal micelles.

Materials

Theaflavins mix: —A mixture of theaflavins was prepared from a commercial concentrated black tea extract (Qunli™ TF60, purchased from Hainan Groupforce Pharmaceutical Co., Ltd. [Hainan Province, China]), as follows. The black tea extract was subjected to macroporous resin chromatography using Diaion™ HP-20 resin (Mitsubishi Chemical Corporation, Tokyo, Japan) eluted with 20% ethanol in water to yield an intermediate mixture comprising around 80% by weight theaflavins. This intermediate mixture was then subjected to column chromatography using Sephadex™ LH 20 eluted with ethanol. The column chromatography was repeated a further two times. The ethanol was then removed from the eluate under vacuum, and the resulting solid was dissolved in de-ionised water and freeze-dried. The resulting solid contained around 95% theaflavins (by weight) of which 10% was theaflavin, 27% was theaflavin-3-gallate, 14% was theaflavin-3′-gallate and 49% was theaflavin-3,3′-digallate.

Bile acid mix: —Glycocholic acid (GC), taurocholic acid (TC), glycodeoxycholic acid (GDC), taurodeoxycholic acid (TDC), taurochenodeoxycholic acid (TCDC) and glycochenodeoxycholic acid (GCDC) were all obtained from Sigma (Poole, Dorset, UK). These acids were used to prepare a bile acid mix which contained (by weight) 23.7% GC, 11.8% TC, 19.6% GDC, 9.4% TDC, 11.8% TCDC and 23.6% GCDC.

Other components: —Oleic acid (OA), mono-olein (MO), lysolecithin (LPC) and cholesterol (Ch) were all obtained from Sigma (Poole, Dorset, UK).

Formation of the Complex

The micelle components, MO, OA, LPC, and Ch were mixed and then dried with N₂. To this dried mixture was added a 500 μl solution of the theaflavins mix and 2 mM bile acid mix in phosphate buffered saline at pH 6.5 and 20° C. This produced a sample having 0.4 mM theaflavins and with concentrations of the micellar components of: 50 μM MO, 100 μM OA, 100 μM LPC, and 80 μM Ch. The sample was then sonicated for 30 minutes at 20° C.

Separation of the Complex from the Remaining Theaflavins

The sample was ultracentrifuged at 50000 g for 30 minutes to pellet the complex (aggregated micelles). The pellet was then separated from the supernatant and the theaflavin content analysed by HPLC. In order to conduct the HPLC analysis the pellet was solubilised in 80% acetonitrile/20% water. The individual theaflavins were separated using a Shimadzu HPLC system (Shimadzu, Hertogenbosch, The Netherlands) and a Chrompack Inertsil™ 5 ODS-2 column (250×4.6 mm) (Chrompack, Middelburg, The Netherlands). The column was kept at 30° C. and run initially isocratic using acetonitrile containing 1% acetic acid, and water containing 1% acetic acid, at a ratio of 22.5%:77.5% (v/v). After 40 minutes the column was washed with pure acetonitrile. A Shimadzu diode array detector was used with detection at 280 nm. The relative amounts of the individual theaflavins from the pellet and supernatant, compared with those of the original theaflavins mix are given in Table 1.

TABLE 1

| | Amount in | Amount in | Amount in |
|---|---|---|---|
| | starting mix | supernatant | pellet |
| Molecule | (wt %) | (wt %) | (wt %) |
| Theaflavin | 10 | 11 | 3 |
| Theaflavin-3-gallate | 27 | 18 | 69 |
| Theaflavin-3′-gallate | 14 | 12 | 21 |
| Theaflavin-3,3′-digallate | 49 | 59 | 7 |
| TOTAL | 100 | 100 | 100 |

The results in Table 1 indicate that the mono-gallated theaflavins (especially theaflavin-3-gallate) are incorporated into the pelleted complex (aggregated micelles) to a much greater extent than the other theaflavins. The ratio R in this example was 2.2.

### Example 2

This example demonstrates that of the various components of the simulated gastro-intestinal micelles constituting the complex of Example 1, it is the phospholipid that is responsible for the selective incorporation of mono-gallated theaflavin therein.

A 0.4 mM mixture of theaflavins (having the composition set forth in Example 1) was prepared in a 2 mM Bile Acid solution in phosphate buffered saline at pH 6.5. This mixture was split into two samples. To one of these samples, L-alpha-phosphatidyl choline was added to a concentration of 100 μM. Both samples were then sonicated and ultracentrifuged as in Example 1. Each pellet was separated from its supernatant and then dissolved in acetonitrile/water as in Example 1. Analysis of the dissolved pellets and supernatants was by HPLC as described in Example 1.

The results showed that for the sample containing phosphatidyl choline, only 5% of the theaflavin and 2% of the theaflavin-3,3′-digallate in the original mixture appear in the pellet. However, 24% of theaflavin-3′-gallate and 41% of the theaflavin-3-gallate in the original mixture are incorporated into the pellet. On the other hand, for the sample without phosphatidyl choline more than 99% of each of the theaflavins was present in the supernatant after ultracentrifugation.

1. A method of producing a theaflavin composition rich in mono-gallated theaflavin, the method comprising the steps of:
a) providing a starting mixture of theaflavins;
b) contacting the starting mixture of theaflavins with phospholipid and a solvent thereby to form a complex and remaining theaflavins, the complex comprising the phospholipid and the theaflavin composition; and
c) separating the complex from the remaining theaflavins.

2. A method according to claim 1 wherein the theaflavin composition comprises at least 50% mono-gallated theaflavin by weight of the theaflavin composition.

3. A method according to claim 1 wherein the mono-gallated theaflavin comprises at least 50% theaflavin-3-gallate by weight of the mono-gallated theaflavin.

4. A method according to claim 1 wherein the starting mixture of theaflavins comprises theaflavin, theaflavin-3-gallate, theaflavin-3′-gallate and theaflavin-3,3′-digallate.

5. A method according to claim 1 wherein the starting mixture of theaflavins comprises less than 50% mono-gallated theaflavin by weight of the starting mixture.

6. A method according to claim 1 wherein the phospholipid comprises phosphatidyl choline.

7. A method according to claim 1 wherein the method comprises the additional step of (d) recovering the theaflavin composition from the complex.

8. A method according to claim 1 wherein the solvent is an aqueous solvent.

9. A method according to claim 1 wherein the weight fraction of mono-gallated theaflavin in the theaflavin composition, is at least 1.1 times the weight fraction of mono-gallated theaflavin in the starting mixture of theaflavins.

10. Use of a phospholipid for purifying mono-gallated theaflavin.
